(19) United States
(12) Patent Application Publication
(10) Pub. No.: US 2026/0212674 A1
(43) Pub. Date: Jul. 23, 2026

(54) SYSTEMS AND TECHNIQUES FOR DUPLICATE CONTENT DETECTION

(71) Applicant: NAGRAVISION SARL, CHESEAUX-SUR-LAUSANNE (CH)

(72) Inventors: Jonathan Bennett-James, CHESEAUX-SUR-LAUSANNE (CH); Craig Holbrook, CHESEAUX-SUR-LAUSANNE (CH)

(73) Assignee: NAGRAVISION SARL, CHESEAUX-SUR-LAUSANNE (CH)

(21) Appl. No.: 19/134,942

(22) PCT Filed: Dec. 13, 2023
(86) PCT No.: PCT/IB2023/062640

§ 371 Date: Jun. 2, 2025

Related U.S. Application Data
(60) Provisional application No. 63/433,224, filed on Dec. 16, 2022.

(51) Int. Cl. G06V 20/40; G06V 10/74; H04N 21/231; H04N 21/234; H04N 21/242

(52) U.S. Cl. CPC G06V 20/48; G06V 10/761; H04N 21/23113; H04N 21/23418; H04N 21/242

(57) ABSTRACT

The present disclosure generally relates to a duplicate identification system. For example, aspects of the present disclosure include systems and techniques for identifying duplication of media content. One example method generally includes: selecting a first frame from a first video and a second frame from a second video; identifying a first section of the first frame, the first section being less than an entirety of the first frame; comparing the first section of the first frame with the second frame; determining whether at least a portion of the first video and at least a portion of the second video are duplicates based on the comparison; and outputting an indication that the portion of the first video and the portion of the second video are duplicates based on the determination.

### CROSS-REFERENCE TO RELATED APPLICATIONS

This application claims priority to U.S. Provisional Patent Application No. 63/433,224, filed Dec. 16, 2022, which is hereby incorporated by reference, in its entirety and for all purposes.

### FIELD

The present disclosure generally relates to a duplicate identification system. For example, aspects of the present disclosure include systems and techniques for identifying duplication of media content.

### BACKGROUND

Physical storage of media can be costly given the volume of content that needs to be stored on a daily basis. With advances in technology, the resolution of videos is increasing. For example, videos stored in 4K resolution is becoming more and more common, and in the future, videos having 8K or even larger resolution may be used. Such videos with large frame sizes consume large amounts of memory to store and often need to be stored in low-latency storage devices for delivery which can be costly. Reducing the footprint associated with the storage of media content is therefore becoming more important.

### SUMMARY

Certain aspects of the present disclosure relate to an apparatus for duplicate detection. The apparatus generally includes: a memory; and one or more processors coupled to the memory, the one or more processors being configured to: select a first frame from a first video and a second frame from a second video; identify a first section of the first frame, the first section being less than an entirety of the first frame; compare the first section of the first frame with the second frame; determine whether at least a portion of the first video and at least a portion of the second video are duplicates based on the comparison; and output an indication of whether at least the portion of the first video and at least the portion of the second video are duplicates based on the determination.

Certain aspects of the present disclosure relate to a method for duplicate detection. The method generally includes: selecting a first frame from a first video and a second frame from a second video; identifying a first section of the first frame, the first section being less than an entirety of the first frame; comparing the first section of the first frame with the second frame; determining whether at least a portion of the first video and at least a portion of the second video are duplicates based on the comparison; and outputting an indication of whether at least the portion of the first video and at least the portion of the second video are duplicates based on the determination.

Certain aspects of the present disclosure relate to a non-transitory computer-readable medium having instructions stored thereon, that when executed by one or more processors, cause the one or more processors to: select a first frame from a first video and a second frame from a second video; identify a first section of the first frame, the first section being less than an entirety of the first frame; compare the first section of the first frame with the second frame; determine whether at least a portion of the first video and at least a portion of the second video are duplicates based on the comparison; and output an indication of whether at least the portion of the first video and at least the portion of the second video are duplicates based on the determination.

### BRIEF DESCRIPTION OF THE DRAWINGS

Illustrative embodiments of the present application are described in detail below with reference to the following drawing figures:

FIG. 1 is a diagram illustrating an example duplicate identification system implemented using a computing device, in accordance with certain aspects of the present disclosure.

FIG. 2 illustrates a duplicate identification system, in accordance with certain aspects of the present disclosure.

FIG. 3 illustrates different frame sections used for image comparison, in accordance with certain aspects of the present disclosure.

FIG. 4 illustrates example techniques for performing image comparison using an iterative approach, in accordance with certain aspects of the present disclosure.

FIG. 5 illustrates a sports match streaming on television and being recorded using a camera.

FIG. 6 is a flow diagram illustrating example operations for duplicate identification, in accordance with certain aspects of the present disclosure.

FIG. 7 illustrates an architecture of a computing system.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Storage is finite and there is a cost associated with storage. This cost can be relatively low for physical drives or more expensive for content delivery network (CDN) capacity. Storing large amounts of duplicate data is not desirable. Storing video with large resolutions (e.g., 4K video formats with frames having a size of 3840 pixels×2160 pixels) can require large amounts of storage. Videos may also need to be stored in low-latency storage devices, which may be limited in storage capacity. Thus, techniques are needed for reducing the storage footprint of content.

Furthermore, content is often shared on the Internet and identifying streams of copyright content can be difficult and costly. A common approach to avoid detection of piracy is to letterbox or modify an area of the image at some part of the screen that will not interfere with the user's viewing. These techniques make duplicate identification difficult. By randomly sampling areas of the frame and looking for color alignment rather than an exact full image match may make it more difficult for entities to avoid detection when pirating content.

Certain aspects of the present disclosure are directed towards identifying duplicate content in order to prevent content from being stored (e.g., by causing a duplicated version of the content not to be stored or by deleting the duplicated version of the content). Such aspects can allow for the reduction of storage space and prevention of piracy. For example, identification of duplicate content may allow for reduction of a storage footprint by preventing the same content from being stored in different locations in memory. Moreover, identifying duplicate content may allow for the identification of acts of piracy (e.g., piracy of videos that may be streaming on various video streaming sites), facilitating the prevention of such acts of piracy in the future.

When performing deduplication of video data sets, particularly data sets from multiple providers, it may be difficult to guarantee that two pieces of content are indeed duplicate content rather than simply being different content that, at a high level, appear to be duplicated. For example, two pieces of content may have the same name but may not be duplicate content. Identifying duplicate content may be especially difficult with multiple content suppliers who may supply different IDs for the same content and could even supply slightly differing metadata for the same content. When looking to identify duplicate content, various metadata fields may be considered, but merely considering metadata, such as title, or ID, may provide inaccurate results and is prone to errors. In a production environment, any content deduplication process or content matching process must be accurate as displaying the wrong content, displaying content with the incorrect age rating, or losing unique paid-for content, is not acceptable by operators and customers. Therefore, some aspects of the present disclosure provide techniques for identifying duplicate content using content-level data, as described in more detail herein.

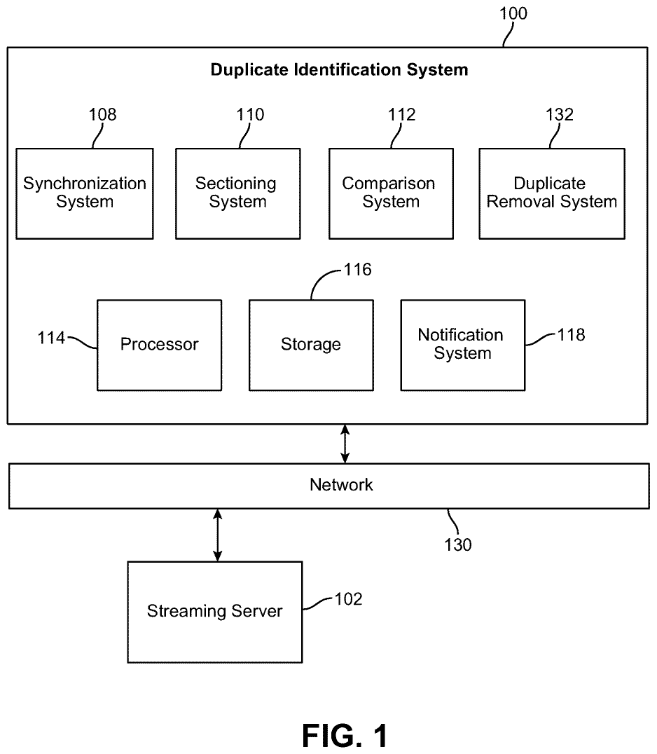

FIG. 1 is a diagram illustrating an example duplicate identification system 100 implemented using a computing device, in accordance with some examples. In the example shown, the duplicate identification system 100 may include storage 116 and processor 114. The storage 116 can include any storage device(s) for storing data. The storage 116 can store data from any of the components of the duplicate identification system 100.

In some implementations, the processor 114 can include a central processing unit (CPU), a graphics processing unit (GPU), a digital signal processor (DSP), any combination thereof, or other type of processor. As shown, duplicate identification system 100 may include a synchronization system 108 that may synchronize two streams using partial matching, as described herein. The duplicate identification system 100 may include a sectioning system 110 that may identify various sections (e.g., center sections or random sections) in frames. The duplicate identification system 100 may also include a comparison system 112 that may compare two frames or sections of frames. In some aspects, the duplicate identification system 100 may include a duplicate removal system 132 that may, upon identifying duplicate content, remove the duplicate from storage. The duplicate identification system 100 may include a notification system 118. The notification system 118 may send a notification of pirated content after identifying duplication. The notification may be sent via network 130. In some cases, the network 130 communicably couples the duplicate identification system 100 to a streaming server 102, from which video content may be received for duplicate analysis.

In some aspects, at least one of the synchronization system 108, the sectioning system 110, the comparison system 112, duplicate removal system 132, or notification system 118 may be implemented as part of the processor 114 and/or implemented as instructions in storage 116. At least one of the synchronization system 108, the sectioning system 110, the comparison system 112, duplicate removal system 132, or the notification system 118 may be implemented in hardware, software, or a combination of hardware and software. In some aspects, at least one of the synchronization system 108, the sectioning system 110, the comparison system 112, duplicate removal system 132, or notification system 118 may be implemented by or in the same hardware, software, or combination of hardware and software (e.g., by the same processor). In some aspects, at least one of the synchronization system 108, the sectioning system 110, the comparison system 112, duplicate removal system 132, or notification system 118 may be implemented by or in separate hardware, software, or combination of hardware and software.

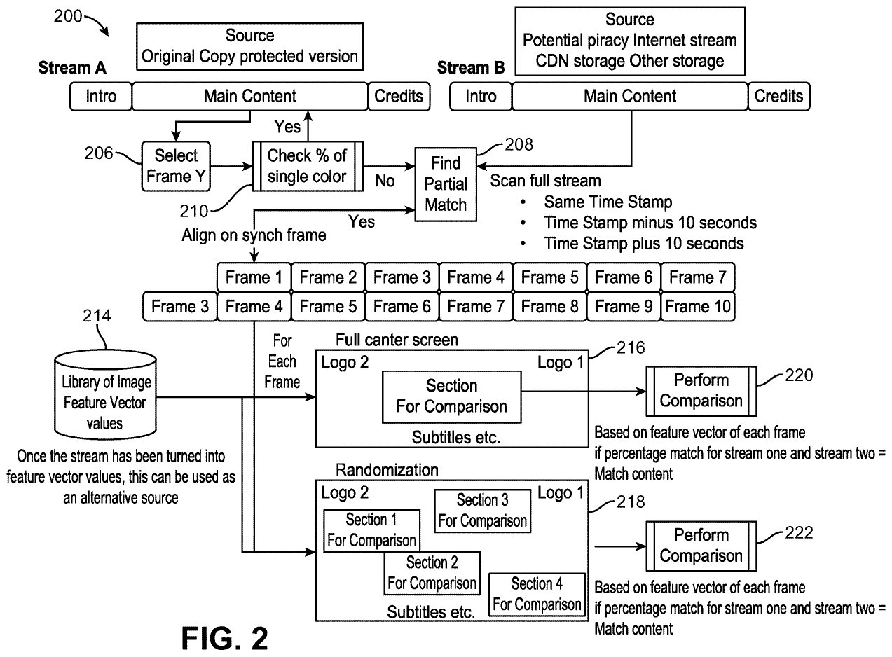

FIG. 2 illustrates a duplicate identification system 200, in accordance with certain aspects of the present disclosure. The duplicate identification system 200 may receive a feed of two streams. One stream may be considered as the original stream (e.g., also referred to as the master stream or video stream A), and the other stream may be considered the second stream (e.g., also referred to as video stream B). Stream A may be an original protected version of media content, and stream B may be potential pirated content, Internet stream, CDN storage, or other storage of media content.

In some aspects, to save time/resources, the duplicate identification system may establish a basic (e.g., low percentage match) first match (also referred to herein as a partial match) to synch timestamps. Using the basic duplication match, a specific timestamp in each of the video streams may be identified to synchronize the streams. For instance, at block 206, a frame Y in stream A at a specified timestamp may be selected. At block 210, duplicate identification system 200 may identify whether a percentage of a single color in frame Y is greater than a threshold. If so, a different frame may be selected, since a frame having a significant amount of a single color (e.g., black) may not be a good candidate for match detection.

Similarly, frames Z in stream B at the specified timestamp +/− an offset time period (e.g., +/−10 seconds from the timestamp) may be selected. The frame Y of stream A may be compared to frames Z of stream B to find a partial match between two frames of streams A and B at block 208. The offset time period may be configurable. For example, a longer offset time period may be selected to increase the probability of detecting the partial match. Once the partial match is identified at block 208, the timestamp associated with the matched frames may be used for synchronizing of frames of the two streams (stream A and stream B). As shown, the frames may be aligned on the synch frames (e.g., frame 1 of stream A may be synchronized with frame 4 of stream B). The partial match may be identified using any suitable image comparison technique.

Once the frames are synchronized using the partial match, the match is further refined in case the partial match is in error (e.g., the partial match may be due to two frames from different content being similar). To further refine the match, one or more matching techniques may be used. For example, either one or more center sections of frames may be used, or randmoly selected sections may be used, as described in more detail herein herein.

In some aspects, the duplicate identification system 200 may include an image database 214 may include a library of image feature vector values. Once a stream (e.g., stream A) has been converted to feature vector values, the feature vector values may be stored in image database 214 and used as a source for image comparison. Image feature vector values provide a list of numbers representing a whole image (e.g., each frame of the stream), which may be used for image similarity calculations or image classification tasks.

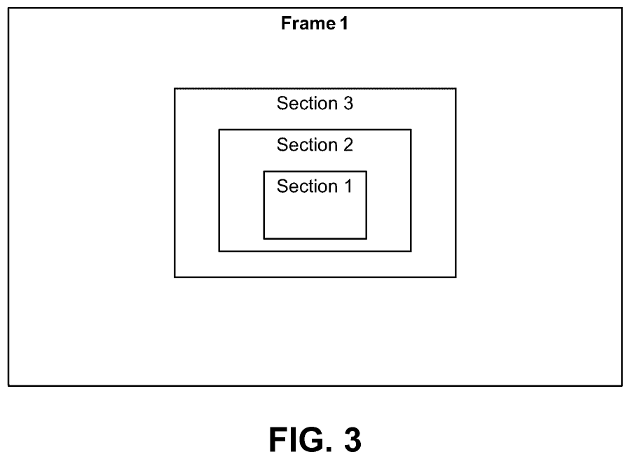

In some aspects of the present disclosure, for each frame of the streams, a portion of each frame from stream A may be compared to a portion of the corresponding frame from stream B. For example, the center portion of frame 216 of stream A may be compared, at block 220, to the corresponding portion of a corresponding frame of stream B, as shown. If the percentage match between the two streams is greater than a threshold, a match output may be provided by the duplicate identification system 200. A match or percentage match may be determined using any suitable manner, such as by comparing pixels of images or frames. In some aspects, expanding frame sections may be used for image comparison, each expansion improving match confidence, as described in more detail with respect to FIG. 3.

FIG. 3 illustrates different frame sections used for image comparison, in accordance with certain aspects of the present disclosure. As shown, a first section (section 1) of a frame in stream A may be compared to the corresponding portion of a frame in stream B. If the percentage match between the two streams for section 1 is greater than a threshold, duplicate identification system 200 may expand the section size and perform another image match. For example, a second section (section 2) of the frame in stream A may be compared to the corresponding portion of the frame in stream B. If the percentage match between the two streams for section 2 is greater than a threshold, duplicate identification system 200 may again increase the section size and perform the same process for section 3, and so on. The size of the sections may be increased in any suitable manner. For example, the size may be increased from one, two, or three sides only. While three sections are illustrated in FIG. 3 to facilitate understanding, any number of sections (e.g., equal to or greater than 2 sections) may be used.

Referring back to FIG. 2, in some aspects, image comparison may be performed using randomized frame sections. For instance, a first section (section 1) of frame 218 of stream A may be selected. At block 222, section 1 may be compared with a section of a corresponding frame of stream B. The location of the section in the frame, and in some aspects, the size of the section, may be selected at random. Once the comparison is performed for section 1, another random section (section 2) may be selected for image comparison. While a total of four randomly selected sections are shown in FIG. 2, any number of sections may be used until a certain confidence threshold has been reached that the two frames are duplicates.

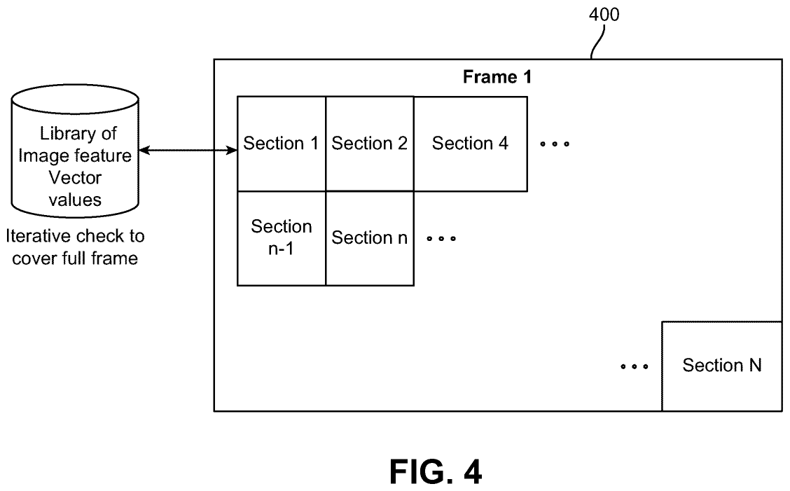

FIG. 4 illustrates example techniques for performing image comparison using an iterative approach, in accordance with certain aspects of the present disclosure. As shown, a full frame 400 may be scanned one section at a time using an iterative check. For instance, a first comparison check may be performed for a first section (section 1) located on the top left portion of the frame, then a second comparison check may be performed for a second section located to the right of the first section, and so on, until the entire frame is covered. As shown, the sections may at least partially overlap. As shown, a total of N sections may be used for image comparison, N being any integer greater than 1.

In some aspects, the iterative approach described with respect to FIG. 4 may be used in conjunction with the randomized approach. For instance, a random section (e.g., section 1 shown in FIG. 2) of frame 218 of stream A may be selected as described with respect to FIG. 2. The selected random section may be compared to the frame in stream B using the iterative approach. For example, random section 1 may be checked against each of the sections of stream B as shown in FIG. 4 until a match is found. For example, a match may be identified when the random section 1 is compared against section n of full frame 400.

Using the random selection approach (e.g., in conjunction with the iterative scanning approach) allows for the identification of duplicated content where the content is cropped or otherwise edited to escape detection. For example, an entity or individual attempting to pirate content may add a logo or watermark to the video. As another example, the video may be edited, or the video may be captured on a screen using a camera. For instance, pay-per-view content may be ordered and an individual may use a camera to record his or her screen that is displaying the pay-per-view content. Using the recording from the camera, the individual may live stream the content to others. In these cases, finding the pirating attempt may be difficult.

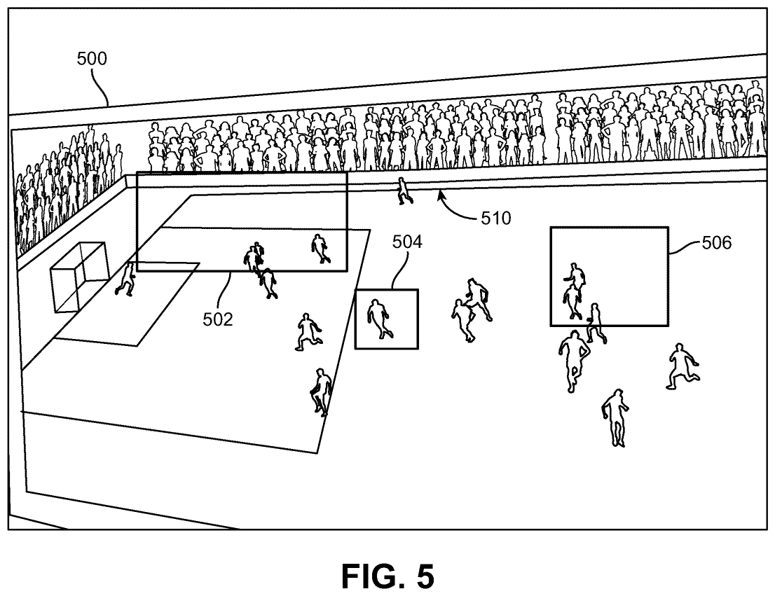

FIG. 5 illustrates a sports match streaming on television 500. As shown, the sport match may be recorded using a camera in front of the television. Thus, the recording from the camera may be very different from the original content showing the sports match. To identify duplication, random sections 502, 504, 506 may be selected and used for image comparison, as described herein. Using the randomized approach, the probability of accurately identifying duplicate content is increased, even when the content is heavily edited.

In some aspects, a range of similarity percentage thresholds may be used to accommodate the possibility that a portion of the frame image contains a channel logo or watermark. For example, when attempting to pirate video content, a logo may be placed on a corner of the video, resulting in a lower similarity percentage when performing an image comparison. Therefore, a lower similarity percentage threshold may be used in specific regions of the frame (e.g., top right or top left portions). A similarly percentage threshold may represent how similar two sections of a frame would have to be before the sections are considered duplicate using image comparison.

In some aspects, one or more regions (e.g., top right or top left portions) of the frame may not be considered when performing the image comparison. In other words, knowing that logos are often placed on a corner of the video, image comparison may be configured not to consider the corners.

In some aspects, the randomized approach described herein may be performed along with further image analysis for alignment of reference frames (e.g., using pitch marking or points of interest). For example, writing in a video stream (e.g., writing 510) may be identified and used to align a section (e.g., section 502) of a frame of stream B with a corresponding section in a frame of stream A for image comparison. The randomized approach described herein may be carried out using any suitable randomization algorithm.

In some aspects, to increase the efficiency of duplicate identification, once random sections of a frame (e.g., of stream A) have been converted into feature vector values, those values may be stored in a data store (e.g., in image database 214). This allows duplicate identification system 200 to quickly look up information associated with a section for comparison to various live streams or Internet hosted content to identify duplication.

As described, the duplicate identifying system described herein may be used to identify duplicate content in storage. In this case, once a duplicate is identified, duplicate identification system 200 may delete one of the duplicates from storage to free storage space. In some implementations, the duplicate identification system may be used to identify pirated content. In this case, once a duplicate is identified, duplicate identification system 200 may send or log an alert that a duplicate is detected with the details of the duplicate such as the name, ID, or uniform resource locator (URL). The content may also be tagged as a duplicate, or a pointer could be created to a master copy of the content instead of storing two versions.

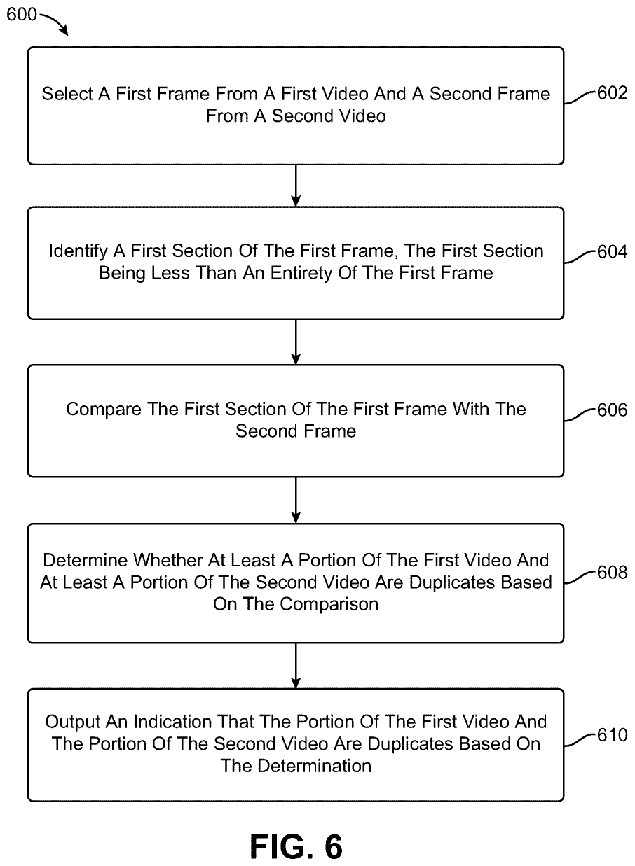

FIG. 6 illustrates example operations 600 for duplicate detection, in accordance with certain aspects of the present disclosure. The operations 600 may be performed, for example, by a duplicate identification system, such as the duplicate identification system 100 or the duplicate identification system 200.

At block 602, the duplicate identification system may select a first frame (e.g., frame 1 shown in FIG. 2) from a first video (e.g., stream A shown in FIG. 2) and a second frame from a second video. To select the first frame from the first video and the second frame from the second video, the duplicate identification system may perform an image comparison to synchronize the first video and the second video.

At block 604, the duplicate identification system identifies a first section of the first frame, the first section being less than an entirety of the first frame. At block 606, the duplicate identification system compares the first section of the first frame with the second frame. For example, comparing the first section of the first frame with the second frame may include comparing the first section of the first frame with a second section of the second frame.

At block 608, the duplicate identification system may determine whether at least a portion of the first video and at least a portion of the second video are duplicates based on the comparison. To determine whether at least the portion of the first video and at least the portion of the second video are duplicates, the duplicate identification system may identify whether a percentage match between the first section of the first frame and a second section of the second frame is greater than a threshold.

In some aspects, the first section may be a first center section (e.g., section 1 shown in FIG. 3) of the first frame. The duplicate identification system may identify a second center section (e.g., section 2 shown in FIG. 3) of the first frame, the second center section including the first center section. The duplicate identification system may compare the second center section of the first frame with the second frame. Determining whether at least the portion of the first video and at least the portion of the second video are duplicates may be further based on the comparison of the second center section with the second frame.

In some aspects, the first section of the first frame may be randomly identified (e.g., as described with respect to section 1 of frame 218 in FIG. 2). Duplicate identification system may randomly identify a second section of the first frame and compare the second randomly identified section of the first frame with the second frame. Determining whether at least the portion of the first video and at least the portion of the second video are duplicates may be further based on the comparison of the second randomly identified section with the second frame.

In some aspects, a duplicate identification system may identify a second section of the first frame, the second section being adjacent to the first section. The duplicate identification system may compare the second section of the first frame with the second frame. Determining whether at least the portion of the first video and at least the portion of the second video are duplicates may be further based on the comparison of the second section with the second frame.

In some aspects, to compare the first section of the first frame with the second frame, the duplicate identification system is configured to compare the first section to each adjacent section of multiple adjacent sections of the second frame (e.g., adjacent sections shown in FIG. 4). At least two of the multiple adjacent sections may partially overlap.

In some aspects, to compare the first section of the first frame with the second frame, the duplicate identification system is configured to retrieve, from a database (e.g., image database 214), image feature vector values associated with the first section.

At block 610, the duplicate identification system outputs an indication of whether at least the portion of the first video and at least the portion of the second video are duplicates based on the determination. For example, the duplicate identification system may determine that at least the portion of the first video and at least the portion of the second video are duplicate based on the comparison, in which case the indication indicates that at least the portion of the first video and at least the portion of the second video are duplicates. The duplicate identification system may, based on the indication that at least the portion of the first video and at least the portion of the second video are duplicates, delete the first video or the second video from storage.

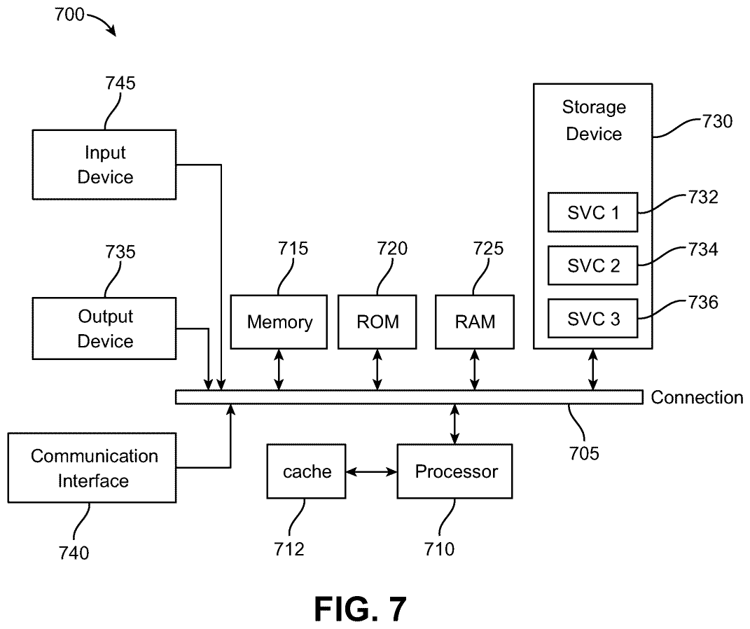

FIG. 7 illustrates an architecture of a computing system 700 wherein the components of the computing system 700 are in electrical communication with each other using a connection 705, such as a bus. Exemplary computing system 700 includes a processing unit (CPU or processor) 710 and a system connection 705 that couples various system components including the system memory 715, such as read only memory (ROM) 720 and random-access memory (RAM) 725, to the processor 710. The computing system 700 can include a cache of high-speed memory connected directly with, in close proximity to, or integrated as part of the processor 710. The computing system 700 can copy data from the memory 715 and/or the storage device 730 to the cache 712 for quick access by the processor 710. In this way, the cache can provide a performance boost that avoids processor 710 delays while waiting for data. These and other modules can control or be configured to control the processor 710 to perform various actions. Other system memory 715 may be available for use as well. The memory 715 can include multiple different types of memory with different performance characteristics. The processor 710 can include any general-purpose processor and a hardware or software service, such as service 1 732, service 2 734, and service 3 736 stored in storage device 730, configured to control the processor 710 as well as a special-purpose processor where software instructions are incorporated into the actual processor design. The processor 710 may be a completely self-contained computing system, containing multiple cores or processors, a bus, memory controller, cache, etc. A multi-core processor may be symmetric or asymmetric.

To enable client interaction with the computing system 700, an input device 745 can represent any number of input mechanisms, such as a microphone for speech, a touch-sensitive screen for gesture or graphical input, keyboard, mouse, motion input, speech and so forth. An output device 735 can also be one or more of a number of output mechanisms known to those of skill in the art. In some instances, multimodal systems can enable a client to provide multiple types of input to communicate with the computing system 700. The communications interface 740 can generally govern and manage the client input and system output. There is no restriction on operating on any particular hardware arrangement and therefore the basic features here may easily be substituted for improved hardware or firmware arrangements as they are developed.

Storage device 730 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 725, read only memory (ROM) 720, and hybrids thereof.

The storage device 730 can include services 732, 734, 736 for controlling the processor 710. Other hardware or software modules are contemplated. The storage device 730 can be connected to the system connection 705. In one aspect, a hardware module that performs a particular function can include the software component stored in a computer-readable medium in connection with the necessary hardware components, such as the processor 710, connection 705, output device 735, and so forth, to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the concepts in this disclosure may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random-access memory (RAM) such as synchronous dynamic random-access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules.

Illustrative aspects of the disclosure include:

Aspect 1. An apparatus for duplicate detection, comprising: a memory; and one or more processors coupled to the memory, the one or more processors being configured to: select a first frame from a first video and a second frame from a second video; identify a first section of the first frame, the first section being less than an entirety of the first frame; compare the first section of the first frame with the second frame; determine whether at least a portion of the first video and at least a portion of the second video are duplicates based on the comparison; and output an indication of whether at least the portion of the first video and at least the portion of the second video are duplicates based on the determination.

Aspect 2. The apparatus of aspect 1, wherein, to compare the first section of the first frame with the second frame, the one or more processors are configured to compare the first section of the first frame with a second section of the second frame.

Aspect 3. The apparatus of any one of aspects 1 or 2, wherein, to determine whether at least the portion of the first video and at least the portion of the second video are duplicates, the one or more processors are configured to identify whether a percentage match between the first section of the first frame and a second section of the second frame is greater than a threshold.

Aspect 4. The apparatus of any one of aspects 1 to 3, wherein the first section of the first frame includes a first center section of the first frame.

Aspect 5. The apparatus of aspect 4, wherein the one or more processors are configured to: identify a second center section of the first frame, the second center section including the first center section; compare the second center section of the first frame with the second frame; and determine whether at least the portion of the first video and at least the portion of the second video are duplicates further based on the comparison of the second center section with the second frame.

Aspect 6. The apparatus of any one of aspects 1 to 5, wherein the first section of the first frame is identified using a randomization algorithm.

Aspect 7. The apparatus of aspect 6, wherein the one or more processors are configured to: identify a second section of the first frame using a randomization algorithm; compare the second section of the first frame with the second frame; and determine whether at least the portion of the first video and at least the portion of the second video are duplicates further based on the comparison of the second section with the second frame.

Aspect 8. The apparatus of any one of aspects 1 to 7, wherein the one or more processors are configured to: identify a second section of the first frame, the second section being adjacent to the first section; compare the second section of the first frame with the second frame; and determine whether at least the portion of the first video and at least the portion of the second video are duplicates further based on the comparison of the second section with the second frame.

Aspect 9. The apparatus of any one of aspects 1 to 8, wherein, to select the first frame from the first video and the second frame from the second video, the one or more processors are configured to perform an image comparison to synchronize the first video and the second video.

Aspect 10. The apparatus of any one of aspects 1 to 9, wherein, to compare the first section of the first frame with the second frame, the one or more processors are configured to retrieve, from a database, image feature vector values associated with the first section.

Aspect 11. The apparatus of any one of aspects 1 to 10, wherein the one or more processors are configured to: determine that at least the portion of the first video and at least the portion of the second video are duplicate based on the comparison, wherein the indication indicates that at least the portion of the first video and at least the portion of the second video are duplicates; and delete, based on the indication, the first video or the second video from storage.

Aspect 12. The apparatus of any one of aspects 1 to 11, wherein, to compare the first section of the first frame with the second frame, the one or more processors are configured to compare the first section to each adjacent section of multiple adjacent sections of the second frame.

Aspect 13. The apparatus of aspect 12, wherein at least two of the multiple adjacent sections at least partially overlap.

Aspect 14. A method for duplicate detection, comprising: selecting a first frame from a first video and a second frame from a second video; identifying a first section of the first frame, the first section being less than an entirety of the first frame; comparing the first section of the first frame with the second frame; determining whether at least a portion of the first video and at least a portion of the second video are duplicates based on the comparison; and outputting an indication of whether at least the portion of the first video and at least the portion of the second video are duplicates based on the determination.

Aspect 15. The method of aspect 14, wherein comparing the first section of the first frame with the second frame includes comparing the first section of the first frame with a second section of the second frame.

Aspect 16. The method of any one of aspects 14 or 15, wherein determining whether at least the portion of the first video and at least the portion of the second video are duplicates includes identifying whether a percentage match between the first section of the first frame and a second section of the second frame is greater than a threshold.

Aspect 17. The method of any one of aspects 14 to 16, wherein the first section of the first frame includes a first center section of the first frame.

Aspect 18. The method of aspect 17, further comprising: identifying a second center section of the first frame, the second center section including the first center section; and comparing the second center section of the first frame with the second frame, wherein determining whether at least the portion of the first video and at least the portion of the second video are duplicates is further based on the comparison of the second center section with the second frame.

Aspect 19. The method of any one of aspects 14 to 18, wherein the first section of the first frame is randomly identified.

Aspect 20. A non-transitory computer-readable medium having instructions stored thereon, that when executed by one or more processors, cause the one or more processors to: select a first frame from a first video and a second frame from a second video; identify a first section of the first frame, the first section being less than an entirety of the first frame; compare the first section of the first frame with the second frame; determine whether at least a portion of the first video and at least a portion of the second video are duplicates based on the comparison; and output an indication of whether at least the portion of the first video and at least the portion of the second video are duplicates based on the determination.

Aspect 21. A non-transitory computer-readable storage medium having stored thereon instructions that, when executed by at least one processor, cause the at least one processor to perform operations according to any of aspects 14 to 18.

Aspect 22. An apparatus for providing virtual content for display, the apparatus comprising one or more means for perform operations according to any of aspects 14 to 18.

1. An apparatus for duplicate detection, comprising:
a memory; and
one or more processors coupled to the memory, the one or more processors being configured to:
select a first frame from a first video and a second frame from a second video;
identify a first section of the first frame, the first section being less than an entirety of the first frame;
compare the first section of the first frame with the second frame;
determine whether at least a portion of the first video and at least a portion of the second video are duplicates based on the comparison; and
output an indication of whether at least the portion of the first video and at least the portion of the second video are duplicates based on the determination.

2. The apparatus of claim 1, wherein, to compare the first section of the first frame with the second frame, the one or more processors are configured to compare the first section of the first frame with a second section of the second frame.

3. The apparatus of claim 1, wherein, to determine whether at least the portion of the first video and at least the portion of the second video are duplicates, the one or more processors are configured to identify whether a percentage match between the first section of the first frame and a second section of the second frame is greater than a threshold.

4. The apparatus of claim 1, wherein the first section of the first frame includes a first center section of the first frame.

5. The apparatus of claim 4, wherein the one or more processors are configured to:
identify a second center section of the first frame, the second center section including the first center section;
compare the second center section of the first frame with the second frame; and
determine whether at least the portion of the first video and at least the portion of the second video are duplicates further based on the comparison of the second center section with the second frame.

6. The apparatus of claim 1, wherein the first section of the first frame is identified using a randomization algorithm.

7. The apparatus of claim 6, wherein the one or more processors are configured to:
identify a second section of the first frame using a randomization algorithm;
compare the second section of the first frame with the second frame; and
determine whether at least the portion of the first video and at least the portion of the second video are duplicates further based on the comparison of the second section with the second frame.

8. The apparatus of claim 1, wherein the one or more processors are configured to:
identify a second section of the first frame, the second section being adjacent to the first section;
compare the second section of the first frame with the second frame; and
determine whether at least the portion of the first video and at least the portion of the second video are duplicates further based on the comparison of the second section with the second frame.

9. The apparatus of claim 1, wherein, to select the first frame from the first video and the second frame from the second video, the one or more processors are configured to perform an image comparison to synchronize the first video and the second video.

10. The apparatus of claim 1, wherein, to compare the first section of the first frame with the second frame, the one or more processors are configured to retrieve, from a database, image feature vector values associated with the first section.

11. The apparatus of claim 1, wherein the one or more processors are configured to:
determine that at least the portion of the first video and at least the portion of the second video are duplicate based on the comparison, wherein the indication indicates that at least the portion of the first video and at least the portion of the second video are duplicates; and
delete, based on the indication, the first video or the second video from storage.

12. The apparatus of claim 1, wherein, to compare the first section of the first frame with the second frame, the one or more processors are configured to compare the first section to each adjacent section of multiple adjacent sections of the second frame.

13. The apparatus of claim 12, wherein at least two of the multiple adjacent sections at least partially overlap.

14. A method for duplicate detection, comprising:
selecting a first frame from a first video and a second frame from a second video;
identifying a first section of the first frame, the first section being less than an entirety of the first frame;
comparing the first section of the first frame with the second frame;
determining whether at least a portion of the first video and at least a portion of the second video are duplicates based on the comparison; and
outputting an indication of whether at least the portion of the first video and at least the portion of the second video are duplicates based on the determination.

15. The method of claim 14, wherein comparing the first section of the first frame with the second frame includes comparing the first section of the first frame with a second section of the second frame.

16. The method of claim 14, wherein determining whether at least the portion of the first video and at least the portion of the second video are duplicates includes identifying whether a percentage match between the first section of the first frame and a second section of the second frame is greater than a threshold.

17. The method of claim 14, wherein the first section of the first frame includes a first center section of the first frame.

18. The method of claim 17, further comprising:
identifying a second center section of the first frame, the second center section including the first center section; and
comparing the second center section of the first frame with the second frame, wherein determining whether at least the portion of the first video and at least the portion of the second video are duplicates is further based on the comparison of the second center section with the second frame.

19. The method of claim 14, wherein the first section of the first frame is randomly identified.

20. A non-transitory computer-readable medium having instructions stored thereon, that when executed by one or more processors, cause the one or more processors to:
select a first frame from a first video and a second frame from a second video;
identify a first section of the first frame, the first section being less than an entirety of the first frame;
compare the first section of the first frame with the second frame;
determine whether at least a portion of the first video and at least a portion of the second video are duplicates based on the comparison; and
output an indication of whether at least the portion of the first video and at least the portion of the second video are duplicates based on the determination.
